(19) United States
(12) Patent Application Publication
(10) Pub. No.: US 2004/0143521 A1
(43) Pub. Date: Jul. 22, 2004

(54) Method and device for paying for services in networks with a single sign-on

(76) Inventors: Dieter Barnard, Munchen (DE); Jens Lehmann, Falkensee (DE); Frank Ryll, Berlin (DE)

Correspondence Address: LERNER AND GREENBERG, P.A., Post Office Box 2480, Hollywood, FL, 33022-2480, US

(21) Appl. No.: 10/755,044

(22) Filed: Jan. 9, 2004

(30) Foreign Application Priority Data
Jan. 9, 2003 (DE) 103 00 515.3

(51) Int. Cl. G06F 17/60

(52) U.S. Cl. 705/30

(57) ABSTRACT

A mobile network operator acts as an identity provider for its end customers with respect to external providers of mobile services and content. The operator is therefore also able to assume responsibility for the process of paying for the content and the services. A balance or credit check is carried out already during the authentication and, where applicable, authorization that takes place during the single sign-on process. This enables the mobile network operator to integrate these functions.

### BACKGROUND OF THE INVENTION

### FIELD OF THE INVENTION

To be able to work within a network, whether a mobile radio network or the Internet, it is necessary for a user to receive one or more network identities, also known as accounts. A network ID of this type contains details of the ID, password, addresses, credit card numbers of the user, and, where applicable, also user profiles such as bookmarks, settings, preferences, etc. It has hitherto been customary for communication network users to have to sign on separately for each application they wish to use as the various applications generally run mutually independently. This is especially necessary when the application requires authentication or authorization. As the number of applications users wish to employ grows, so does the number of such user profiles they have to administer. This obviously gives rise to disadvantages, users having to make a note of every profile, where applicable a user ID and password, and, as may also apply, other information they have—or may not have—provided in the relevant profile.

The various solutions now available to address this problem include the “Passport” service from the Microsoft company and the “Liberty Alliance Project” (LAP) (www.projectliberty.org) launched in September 2001.

The specifications of the Liberty Alliance Project describe various methods of authentication and authorization (A&A) aimed at offering end users what is called a single sign-on (SSO) method. An introduction to “single sign-on” not specific to any particular manufacturer can be found at various locations including:

www.opengroup.org/security/sso/sso_intro.htm.

Single sign-on methods of this type have not yet included an integrated solution for paying for services and/or content, the payment process being instead handled separately after the sign-on procedure by, for instance, of the credit card details given.

Mention was made of this shortcoming in “Charging, Billing and Payment views on 3G Business Models”, UMTS Forum Report No. 21, 2002 (www.umts-forum.org/reports.html) dated Jul. 21, 2002, but no solution to the problem was proposed there.

There are, furthermore, some limited solutions in mobile radio networks permitting users to pay for external services and content in the context of pre-paid services.

Handling is possible, for example, using a credit (“wallet”) server made available by the mobile network operator, via which explicit user authentication and authorization is first carried out. This solution is expensive, however, and suitable only for higher-value transactions.

Content can also be invoiced indirectly by way of the transportation charges (for example through a familiar “0900” number). This solution is not very transparent for the user (which is to say the charges invoiced in respect of the content cannot be separated from those for the connection and so cannot be fully comprehended). Having been abused of late by unscrupulous providers, this solution has now fallen into disrepute. The external provider is able to inject the price information into the data stream when the service is being delivered. This is then intercepted by the mobile network operator and evaluated. However, the cost risk is here born by the provider because the service will already have been delivered should the user fail to render payment.

### SUMMARY OF THE INVENTION

It is accordingly an object of the invention to provide a method and a device for paying for services in networks with a single sign-on that overcome the above-mentioned disadvantages of the prior art methods and devices of this general type, which discloses an improved method for paying for content and services and a device for putting the method into effect.

With the foregoing and other objects in view there is provided, in accordance with the invention, a method for charging for services or content in a communications network. The method includes the steps of a user signing on to the communications network only once, the user requesting a service or the content from a service provider, performing a check in the communications network at a request of the service provider for ascertaining whether the service provider will be able to charge the user, and enabling a provision of the service or the content on completion of the check.

The object is achieved whereby a mobile network operator (MNO) acts as what is called an identity provider (according to the Liberty Alliance Project architecture for its end customers with respect to external providers (3rd Party ASP) of mobile services and content, and also assumes responsibility for the process for paying for the content and services. This enables the mobile network operator to integrate these functions.

A balance or credit check is carried out already during the authentication and, where applicable, authorization that takes place during the single sign-on process. The result of the check is notified to the external provider so that authorization can, if applicable, be refused in advance if there are insufficient funds to pay for the use of a service. This will be the case if, for instance, the balance of the account of the user is less than the minimum charge for using a service.

Previous payment methods provide for selection or use to take place before a service is reserved or paid for. With the method according to the invention the amount due can be reserved with binding force before a service is used. The method described here links user authentication to authorization and reservation of the amount due before the service is used. The external service provider must confirm delivery of the service for which the amount due has been reserved to the mobile network operator within a period of time to be specified. It is also possible as an option not to reserve the amount due but instead only to give the external service provider a non-binding advisory concerning the availability of sufficient funds.

The invention facilitates the marketing of data services associated with an ever-widening circle of various other providers.

Interactively performed online authorization (also referred to as “Advice-of-Charge”, AoC) and online reservation are linked to online authentication and are the responsibility of the mobile network operator. Being thus relieved of this function, the external service provider only has to confirm that a service has been successfully delivered.

Online authorization is provided by the mobile network operator (also referred to as the “trusted party”), not by the service provider. This relationship based on trust can be crucial to the success of the services as users only have to deal directly with their own mobile network operator.

The distinction made in this description between mobile network operator and service provider does not, however, necessarily mean that these are spatially or legally separate entities. The distinction is made solely to promote clearer understanding and borrows from the terminology of the Liberty Alliance Project. Specialists will be familiar with other arrangements.

In accordance with an added mode of the invention, there is the step of binding a reservation of an amount due to the service provider. Alternatively, a non-binding advisory can be sent concerning successful checking of charging to the service provider.

In accordance with another mode of the invention, there is the step of confirming, through the service provider, a delivery of the service or the content. Additionally, the confirmation of service delivery received must be done within a pre-specified period of time.

In accordance with a further mode of the invention, there is the step of authorizing, via the user, an amount reserved for the service.

With the foregoing and other objects in view there is further provided, in accordance with the invention, a device for a communications network. The device contains a device for authenticating and authorizing, a device for rendering payment, and a device for communicating with a user and with external service providers. The user having previously signed on once only in the communications network, and a service or content can be requested from a service provider by the user via the device for communicating, and after a request to do so by the service provider, a check is performed by the device for authenticating and authorizing to ascertain whether the service provider will be able to duly charge the user for the service or content.

Other features which are considered as characteristic for the invention are set forth in the appended claims.

Although the invention is illustrated and described herein as embodied in a method and a device for paying for services in networks with a single sign-on, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1A is a block diagram of network elements affected by the method according to the invention;

FIG. 1B is a block diagram showing an overview of the known Liberty Alliance Project architecture; and

FIG. 2 is a data flowchart according to the invention.

### DESCRIPTION OF THE PREFERRED EMBODIMENTS

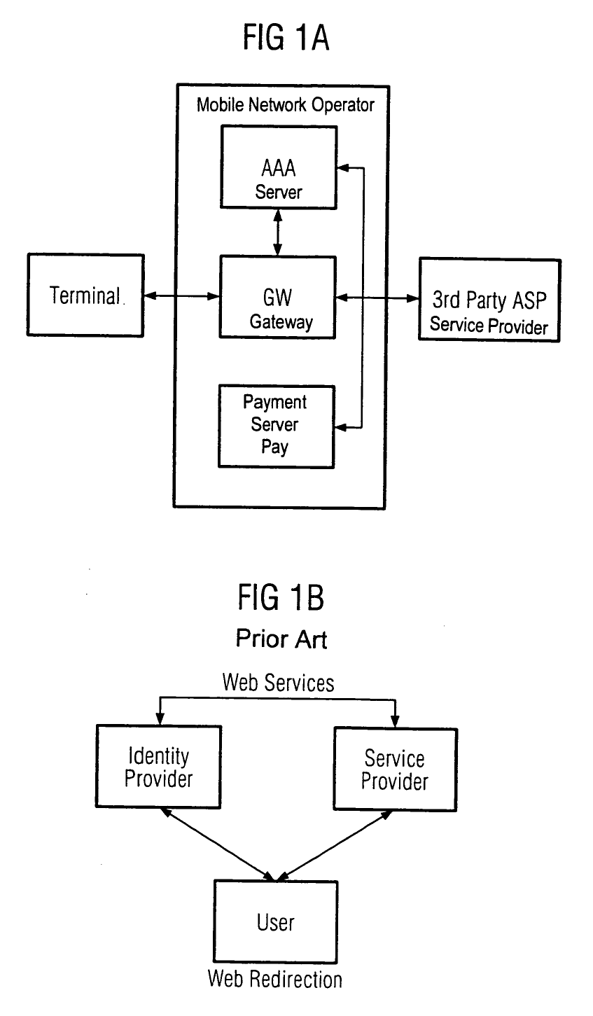

Referring now to the figures of the drawing in detail and first, particularly, to FIG. 1A thereof, there is shown the architecture on which a method according to the invention can be realized. FIG. 1A shows a diagram for communication between a user (Terminal), a mobile network operator (MNO) having an authentication server (AAA Server), a gateway GW (WAP/web proxy, for example), and a payment server PAY, and a service provider (3rd-party application server) on the other side.

FIG. 1B shows the known architecture of the Liberty Alliance Project as currently presented in the official specifications.

The user is faced with two further network elements. A service provider offers the services (web services) required by the user; and the user is first authenticated by an identity provider in a single sign-on process.

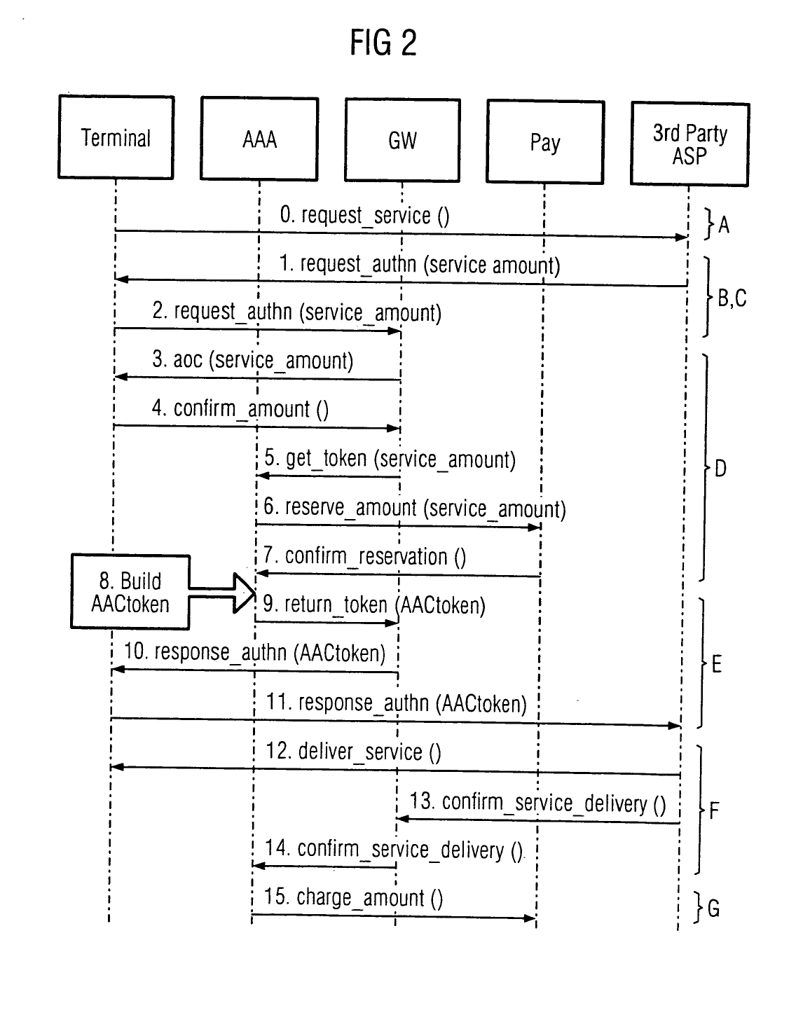

The data flowchart in FIG. 2 shows an example of how the method described here can be implemented.

The following steps are now possible.

A. The user (Terminal) requests a service from the service provider via the mobile radio network of the network operator (request_service( ), 0.).

B. The service provider sends an authentication request (request_authn(service_amount), 1.) to the mobile network operator acting for the user.

C. The authentication request (request_authn(service_amount), 2.) is then sent with the aid of a redirect request to the mobile network operator via the terminal of the user, as shown here.

C′. Alternatively, the authentication request (request_authn(service_amount)) can be sent directly to the mobile network operator in keeping with the LAP specifications.

D. The authentication request contains the price information relating to the requested service (service_amount). This information is used by the mobile network operator to reserve the relevant amount in the account of the user (reserve_amount (service_amount), 6.).

E. After successful reservation (confirm_reservation( ), 7.), the mobile network operator sends the necessary user and service-specific authentication and authorization information (return_token (AACtoken), 9., response_authn(AACtoken), 10.) to the service provider (ASP), along with the information about the reservation that has taken place, response_authn (AACtoken), 11.).

F. The service provider then makes the service available for the user (deliver_service( ), 12.) and informs the mobile network operator that delivery has taken place (confirm_service_delivery( ), 13., 14.).

G. On receipt of delivery confirmation the mobile network operator charges the previously reserved amount to the account of the user (charge_amount( ), 15.). Reservation therefore takes place alongside user authentication and authorization and before the service is made available by the service provider. The mobile network operator can, as an option, also enable authorization (AoC) by the user before the amount is reserved (aoc (service_amount, 3., confirm_amount( ), 4.)

We claim:

1. A method for charging for services or content in a communications network, which comprises the steps of:
a user signing on to the communications network only once;
the user requesting a service or the content from a service provider;
performing a check in the communications network at a request of the service provider for ascertaining whether the service provider will be able to charge the user; and
enabling a provision of the service or the content on completion of the check.

2. The method according to claim 1, which further comprises binding a reservation of an amount due to the service provider.

3. The method according to claim 1, which further comprises sending a non-binding advisory concerning successful checking of charging to the service provider.

4. The method according to claim 1, which further comprises confirming, through the service provider, a delivery of the service or the content.

5. The method according to claim 4, which further comprises providing a confirmation of service delivery received within a pre-specified period of time.

6. The method according to claim 1, which further comprises authorizing, via the user, an amount reserved for the service.

7. A device in a communications network, the device comprising:
means for authenticating and authorizing;
means for rendering payment; and
means for communicating with a user and with external service providers, the user having previously signed on once only in the communications network, and a service or content can be requested from a service provider by the user via said means for communicating, and after a request to do so by the service provider, a check being performed by said means for authenticating and authorizing to ascertain whether the service provider will be able to duly charge the user for the service or content.
